(19) United States
(12) Patent Application Publication
(10) Pub. No.: US 2008/0106045 A1
(43) Pub. Date: May 8, 2008

(54) DECOUPLED SHAFT SEAL FOR A PROGRESSIVE CAVITY PUMP STUFFING BOX

(75) Inventor: JEFFREY LEMBCKE, CYPRESS, TX (US)

Correspondence Address: WONG, CABELLO, LUTSCH, RUTHERFORD & BRUCCULERI,;L.L.P., 20333 SH 249, SUITE 600, HOUSTON, TX, 77070, US

(73) Assignee: WEATHERFORD/LAMB, INC., HOUSTON, TX (US)

(21) Appl. No.: 11/557,392

(22) Filed: Nov. 7, 2006

(51) Int. Cl. F16J 15/16

(52) U.S. Cl. 277/639

(57) ABSTRACT

Stuffing box employing a mechanical seal where the static seal body is laterally decoupled from the stuffing box housing. The static seal body is connected to the housing through a ringed-shaped flexible member. The flexible member flexes with shaft movement transverse to the longitudinal axis of the shaft, so as to absorb the lateral movement of the shaft. Thus, the mechanical seal is maintained while reducing the stresses on the shaft and the internal seals resulting from runout.

### BACKGROUND

Stuffing boxes have long been used on oil wells employing sucker rod pumps. In general, a stuffing box is a device that prevents leakage along a piston, rod, propeller shaft, or other moving part that passes through a hole in a cylinder or vessel. In drilling applications, a sucker rod typically operates through a stuffing box, which prevents the escape of well fluid and diverts the well fluid into a side outlet connected to a flow line. Historically, stuffing boxes typically used packing rings made from various materials to provide a seal. This packing ring design had several drawbacks, including packing breakdown due to wear from the rod's rotation. To solve this problem, internal sleeves that rotated on bearings were sometimes used to prolong seal life.

More recently, stuffing boxes have incorporated mechanical seals. FIGS. 1A-C show a cross-sectional view of a prior art stuffing box 100 including a mechanical seal 130. FIG. 1A shows a view of the entire stuffing box 100, while FIG. 1B illustrates the mechanical seal portion of the stuffing box 100. FIG. 1C shows another embodiment of a prior art stuffing box without an internal sleeve 120. Mechanical seal 130 is designed to seal a rotating shaft 142 entering the stuffing box 100 using two seal bodies 132, 138. The static seal body 138 seals the mechanical seal 130 at the non-moving housing (not shown) of the mechanical seal or, alternatively, at the stuffing box housing 126, while the rotating seal body 132 seals the rotating shaft 142. Typically, a sleeve 120 is employed as an interface between the rotating seal body 132 and the shaft 142, in which case the rotating seal body 132 seals the sleeve 120, which in turn statically seals the shaft 142.

In one design, two bearings 124, a thrust washer 110, and a bushing 140 are positioned in an annular space 106 between the internal sleeve 120 and the stuffing box housing 126, such that the internal sleeve 120 is journalled for rotation within the housing 126. A first bearing 124 is positioned within one of two bearing sleeves 116 and is separated from a second bearing 124 by a bearing separator 118. The thrust washer 110 prevents axial movement of the internal sleeve 120. A leak cock 114 is provided on the stuffing box housing 126 for supplying lubricant to the bearings 124. A shaft cap 104 and static seals 108 are positioned within the sleeve 120 to engage the shaft 142. A rod clamp 102 prohibits movement of the sleeve 120 relative to the shaft 142 so that the sleeve 120 and the shaft 142 move as a unit.

Each of the seal bodies 132, 138 has a sealing surface 134, 136. The seal bodies 132, 138 are typically composed of tungsten carbide (commonly bound by cobalt or nickel), silicon carbide, carbon, or ceramics incorporating these materials, as is well known in the art. The static seal body 138 is biased towards the rotating seal body 132 by a biasing member 144, e.g., a spring.

In operation, the first sealing surface 134 of the rotating seal body 132 rotates against the second sealing surface 136 of the static seal body 138, which remains stationary. A thin fluid film forms between the two sealing surfaces 134, 136. When the two sealing surfaces 134, 136 are pressed together with sufficient force, provided by biasing member 144, the interface of the two sealing bodies 132, 138 creates a high-pressure fluid film that prevents the passage of fluid between the sealing surfaces 134, 136. While the incorporation of the mechanical seal into the stuffing box is an improvement over previous stuffing boxes, there are still disadvantages associated with stuffing boxes employing mechanical seals.

Currently, the seals used in a stuffing box are held tightly between the shaft 142 and the seal bodies 132, 138, which fit tightly in the stuffing box housing 126, to minimize fluid leakage from the seal into the stuffing box 126. For example, the interface between the rotating seal body 132 and the sleeve 120 historically includes an elastomer static inner seal 128 that seals the interface. If no sleeve is used between the rotating seal body 132 and the shaft 142 (as shown in FIG. 1C), an elastomer static inner seal 128 seals the interface between the rotating seal body 132 and the shaft 142, which is journalled for rotation within the housing 126.

Problematically, the shaft 142 moves laterally 150 as it rotates in the mechanical seal 130 during operation, known as runout. Due to the tight fit of the seals in the stuffing box, this runout can create very high stresses on the mechanical seal 130, often causing premature seal failure. Failure of the mechanical seal requires costly and time-consuming maintenance of the stuffing box. It is desirable to prevent the mechanical seal failure in stuffing boxes that is associated with runout and thereby reduce maintenance of the stuffing box.

### SUMMARY

Disclosed herein are stuffing boxes each having a mechanical seal coupled to the stuffing box by a flexible member that flexes with shaft movement transverse to a longitudinal axis of the shaft so as to allow movement of the shaft while maintaining a seal.

### BRIEF DESCRIPTION OF THE DRAWINGS

FIGS. 1A-C show a cross-sectional view of a prior art stuffing box including a mechanical seal.

FIGS. 2A and 2B show a cross-sectional view of a stuffing box having a mechanical seal.

FIG. 3 illustrates an alternative stuffing box without an internal sleeve.

FIG. 4 shows an alternative stuffing box including a separate biasing member.

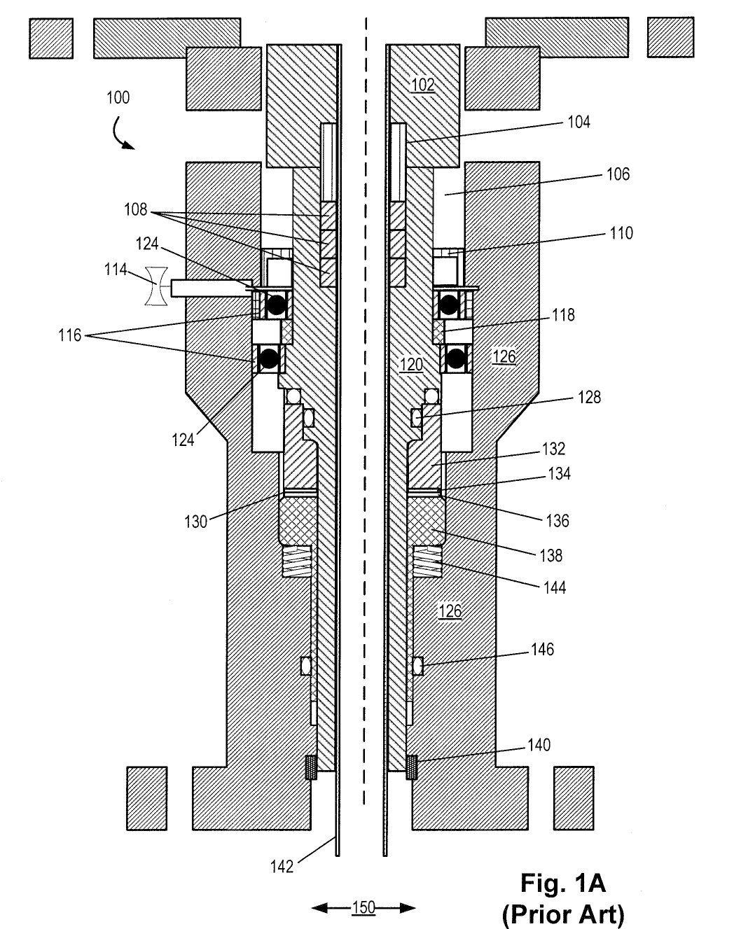

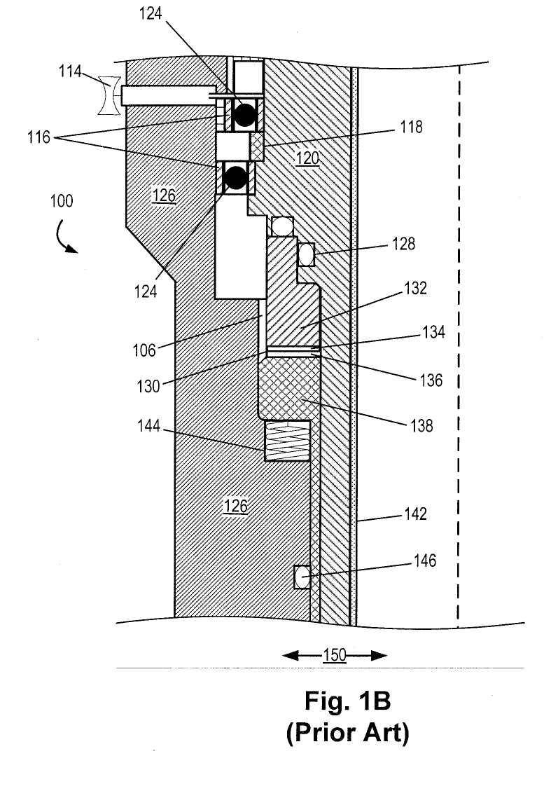

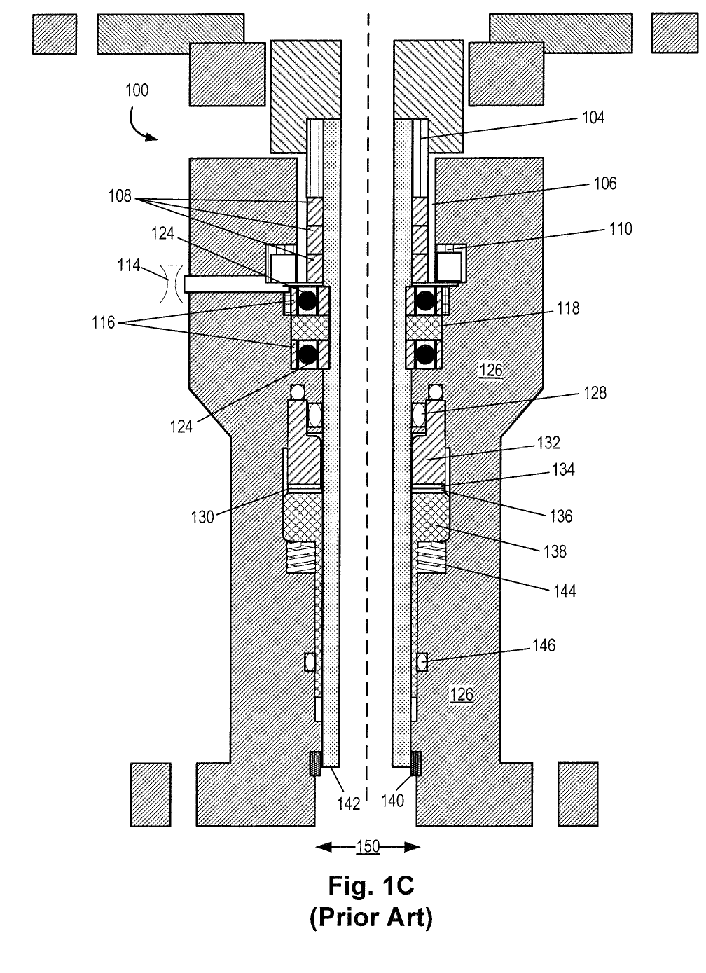

### DETAILED DESCRIPTION

Disclosed herein is a stuffing box employing a mechanical seal where the static seal body is laterally decoupled from the stuffing box housing. The static seal body is connected to the housing through a ringed-shaped flexible member, such as, for example an elastomer boot or a metal bellows. The flexible member flexes with shaft movement transverse to the longitudinal axis of the shaft, so as to absorb the lateral movement of the shaft. Thus, the mechanical seal is maintained while reducing the stresses on the shaft and the internal seals resulting from runout. Specific design details have been provided for illustration but should not be considered limiting. Readers of skill in the art will recognize that many variations of mechanical seal may be implemented in various applications consistent with the scope of the invention as described by the appended claims.

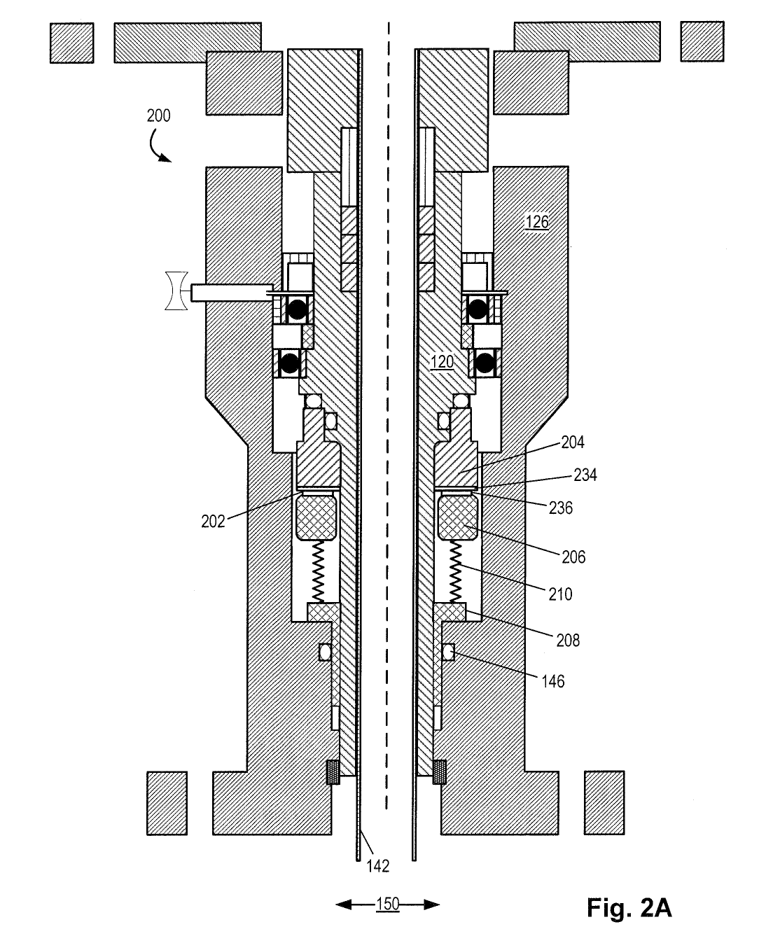

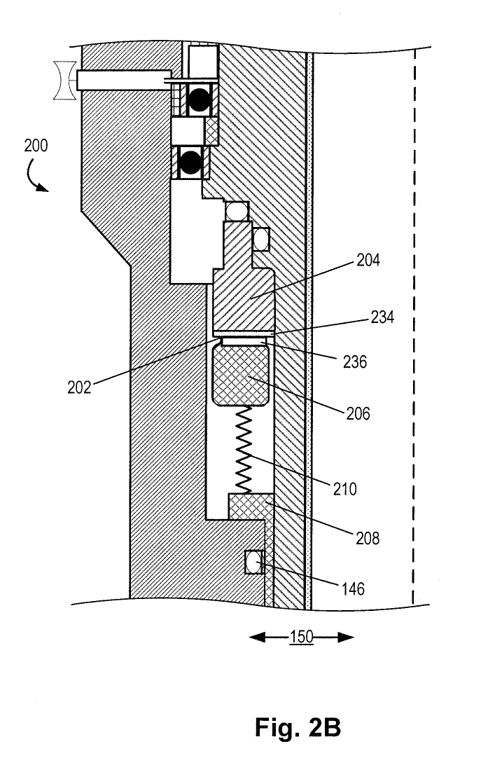

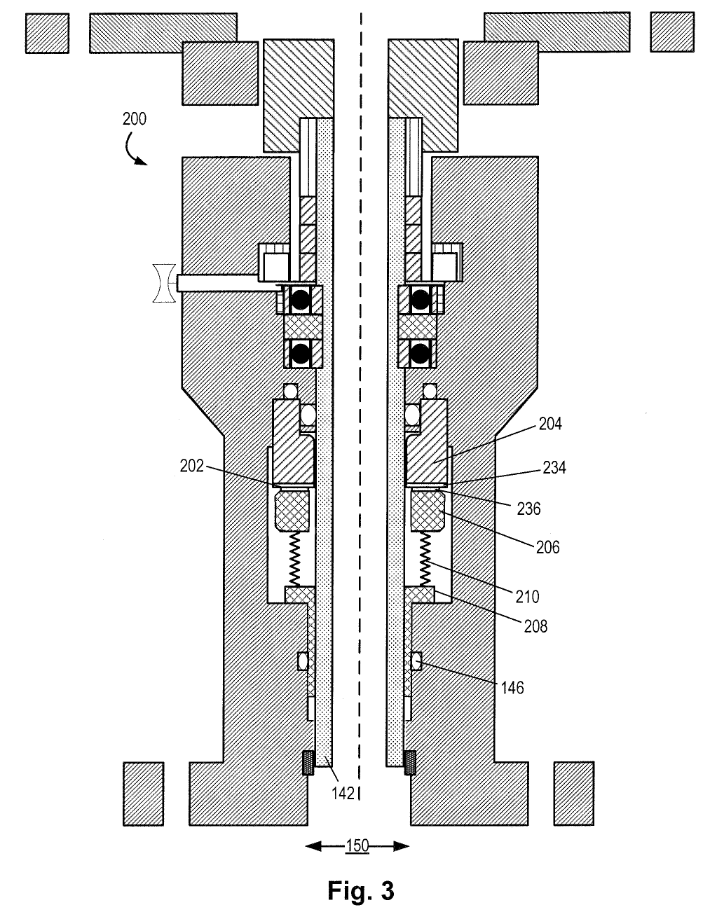

FIGS. 2A and 2B show a cross-sectional view of a stuffing box 200 having a mechanical seal 202. FIG. 2A shows a view of the entire stuffing box 200, while FIG. 2B illustrates the mechanical seal portion of the stuffing box 200. FIG. 3 illustrates an alternative stuffing box 200 without an internal sleeve. Mechanical seal 202, like the prior art mechanical seal, is designed to seal a rotating shaft 142 as it enters the stuffing box 200 with a high-pressure fluid film created between two seal bodies 204, 206. The rotating seal body 204 of mechanical seal 202 may be similar to that of the prior art mechanical seals.

In contradistinction to prior art stuffing boxes, the static seal body 204 of stuffing box 200 is not rigidly fit into the stuffing box housing. Instead, the static seal body 204 may be coupled to the stuffing box housing 126 by a flexible member 210 so that the flexible member 210 maintains the seal between the two sealing surfaces 234, 236. The end of the flexible member 210 opposite of static seal body 206 may be coupled to the stuffing box housing 126 through one or more intervening seal body components, such as an adaptor component 208. The adapter component 208 may be sealed by an elastomer static outer seal 146. In some implementations, the adapter component 208 may also include threads or other fasteners for engaging the stuffing box housing (not shown).

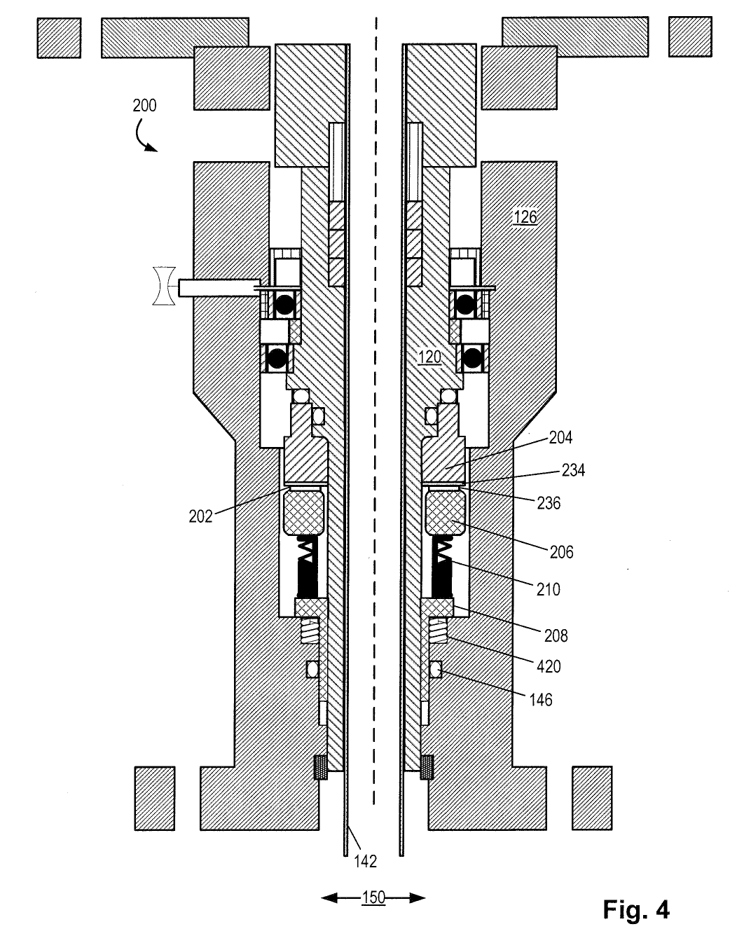

The flexible member 210 may be implemented in many forms, such as, for example, a metal bellows (FIGS. 2A, 2B, and 3), an elastomer boot (FIG. 4), and so on. In some implementations, such as FIGS. 2A, 2B, and 3, the flexible member 210 can be the only biasing member. Thus, the flexible member 210 biases the rotating seal body 204 and the static seal body 206 towards each other.

FIG. 4 shows an alternative stuffing box 200. In the stuffing box 200 of FIG. 4, the flexible member 210 may not function as a biasing member or may not provide sufficient force to maintain a sealing engagement of the sealing surfaces 234, 236. The stuffing box 200 therefore may include a separate biasing member 420. The separate biasing member 420 may support the rotating seal body 204, so that the static seal body 206 is biased towards the rotating seal body 204. One example of a separate biasing member 420 might be a spring, while another example may include an elastomer boot.

In operation, the flexible member 210 and/or separate biasing member 420 presses together the sealing surfaces 234, 236 with sufficient force so that the interface of the sealing surfaces 234, 236 creates a high-pressure fluid film that prevents the passage of fluid between them. The seal between the two sealing surfaces 234, 236 may thereby be maintained. Unlike prior art stuffing boxes, when the rotating shaft 142 moves in a lateral direction 150 due to runout, the flexible member 210 flexes, or sways, to dissipate the forces of the shaft 142 which would otherwise act on the static seals of the stuffing box, increasing wear. Thus, the static seals endure less wear and can have an increased lifespan.

It should be understood that the invention concepts disclosed herein are capable of many modifications. Such modifications may include, but are not limited to, modifications in the materials used for any of the components of the mechanical seal or the remainder of the stuffing box, as well as the number and design of intervening seal body components or the particular design of the flexible member and the mechanical seal. To the extent such modifications fall within the scope of the appended claims and their equivalents, they are intended to be covered by this patent.

1. A stuffing box comprising:
a housing with an internal passage for receiving a shaft; and
a mechanical seal disposed in an annular space between the shaft and the housing to block the passage of fluids, the mechanical seal comprising:
a rotating seal body with a first sealing surface, the rotating seal body for sealingly engaging and rotating with the shaft,
a static seal body having a second sealing surface aligned with the first sealing surface, and
a flexible member coupled to the housing at a first end of the flexible member and the static seal body at a second end of the flexible member so as to flex with shaft movement transverse to a longitudinal axis of the shaft and so as to not rotate with the shaft.

2. The stuffing box of claim 1 wherein the flexible member comprises a metal bellows.

3. The stuffing box of claim 1 wherein the flexible member comprises an elastomer boot.

4. The stuffing box of claim 1 wherein the flexible member is a biasing member so as to bias the rotating seal body and the static seal body towards each other for dynamic sealing engagement of the first and second sealing surfaces.

5. The stuffing box of claim 1 further comprising a biasing member for biasing the rotating seal body and the static seal body towards each other for dynamic sealing engagement of the first and second sealing surfaces.

6. A stuffing box comprising:
a housing;
an internal sleeve positioned within the housing; and
static seals positioned within the internal sleeve, the static seals being adapted to engage a shaft; and
a mechanical seal disposed in the annular space between the internal sleeve and the housing to block the passage of fluids, the mechanical seal comprising:
a rotating seal body with a first sealing surface, the rotating seal body for sealingly engaging and rotating with the sleeve,
a static seal body having a second sealing surface aligned with the first sealing surface, and
a flexible member coupled to the housing at a first end of the flexible member and the static seal body at a second end of the flexible member so as to flex with shaft movement transverse to a longitudinal axis of the shaft and so as to not rotate with the shaft.

7. The stuffing box of claim 6 wherein the flexible member comprises a metal bellows.

8. The stuffing box of claim 6 wherein the flexible member comprises an elastomer boot.

9. The stuffing box of claim 6 wherein the flexible member is a biasing member so as to bias the rotating seal body and the static seal body towards each other for dynamic sealing engagement of the first and second sealing surfaces.

10. The stuffing box of claim 6 further comprising a biasing member for biasing the rotating seal body and the static seal body towards each other for dynamic sealing engagement of the first and second sealing surfaces.
